(19) United States
(12) Patent Application Publication
(10) Pub. No.: US 2008/0104963 A1
(43) Pub. Date: May 8, 2008

(54) Heat Shield Element, Method for Its Production, Hot Gas Lining, and Combustion Chamber

(76) Inventors: Holger Grote, Bonn (DE); Andreas Heilos, Mulheim an der Ruhr (DE); Marc Tertilt, Hattingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/792,130

(22) PCT Filed: Nov. 22, 2005
(86) PCT No.: PCT/EP05/56127

§ 371 Date: Jun. 1, 2007

(30) Foreign Application Priority Data
Dec. 1, 2004 (EP) 04028445.7

(51) Int. Cl. F02C 3/00; C04B 35/64; F23R 3/00

(52) U.S. Cl. 60/753; 264/642

(57) ABSTRACT

Disclosed is a thermal shield element comprising a hot side that is to face a hot medium, a cold side which is to face away from the hot medium, circumferential areas that connect the hot side to the cold side, and a material volume which is delimited by the hot side, the cold side, and the circumferential areas. The inventive thermal shield element is characterized in that the material volume encompasses at least two material zones which differ regarding the thermal expansion coefficient thereof.

### CROSS REFERENCE TO RELATED APPLICATIONS

This application is the US National Stage of International Application No. PCT/EP2005/056127, filed Nov. 22, 2005 and claims the benefit thereof. The International Application claims the benefits of European application No. 04028445.7 filed Dec. 1, 2004, both of the applications are incorporated by reference herein in their entirety.

### FIELD OF INVENTION

The present invention relates to a heat shield element, in particular a ceramic heat shield element, to a method for producing a ceramic heat shield element, to a hot gas lining constructed from heat shield elements, and to a combustion chamber that is fitted with a hot gas lining and can be embodied in particular as a gas turbine combustion chamber.

### BACKGROUND OF THE INVENTION

The walls of combustion chambers, for example gas turbine installations, that contain hot gas require their supporting structure to be thermally shielded against attack by. said hot gas. The thermal shielding can be implemented by means of, for example, a hot gas lining, in the form of, for instance, a ceramic heat shield, mounted in front of the actual combustion chamber wall. A hot gas lining of said type is as a rule constructed from a number of metallic or ceramic heat shield elements with which the combustion chamber wall is lined over its entire surface. Ceramic as compared to metallic materials are ideally suited for constructing a hot gas lining owing to their high thermal stability and resistance to corrosion as well as to their low thermal conductivity. A ceramic heat shield is described in, for example, EP 0 558 540 B1.

U.S. Pat. No. 4,485,630 A discloses a combustor liner having a flat, first alloy strip which has the first thermal coefficient of linear expansion C1 and a flat, second alloy strip which has the thermal coefficient of linear expansion C2.

U.S. Pat. No. 4,838,030 has combustion chamber liners (heat shields) having three layers, a first ceramic layer, a second layer of a filamentary steel wool type entangled metallic material, and a third metallic layer. In this embodiment the metallic layer has coolant passageways.

Owing to thermal expansion characteristics typical of the material and to the temperature differences—say between the ambient temperature when the gas turbine installation is at rest and the maximum temperature at maximum operating load—typically occurring during operation, it must be insured that ceramic heat shields in particular will be free to move following temperature-dependent expansion so that no temperature stresses that would destroy the heat shield will occur owing to the prevention of said temperature-dependent expansion. Expansion gaps are therefore provided between the individual heat shield elements to enable the heat shield elements to thermally expand. Said expansion gaps are for safety reasons designed such that they will never close completely even when the hot gas is at its maximum temperature. It must therefore be insured that the hot gas will not reach the combustion chamber's supporting wall structure through the expansion gaps. To seal the expansion gaps against the ingress of hot gas, they are frequently rinsed with a stream of sealing air flowing toward the combustion chamber's interior. Generally employed as sealing air is air simultaneously serving as cooling air for cooling securing elements that secure the heat shield elements, which results in, among other things, the occurrence of temperature gradients in the region of a heat shield element's edges. The consequence particularly in the case of ceramic heat shield elements is that even when there is no contact between adjacent heat shield elements there will be stresses on the hot side that can cause cracking and so adversely affect the heat shield elements' service life.

To reduce the need for sealing air it has been proposed in EP 1 302 723 A1 to arrange flow barriers in the expansion gaps. That can also lead to a reduction in the temperature gradient in the region of the edges. It is not, though, always readily possible to install flow barriers; doing so will, moreover, increase a heat shield's complexity.

Alternative approaches consist in using heat shield elements made of metal. However, although more resistant than ceramic heat shield elements to variations in temperature and mechanical loading, metallic heat shield elements require, for example in gas turbine combustion chambers, complex cooling of the heat shield because they have a higher thermal conductivity than ceramic heat shield elements. Metallic heat shield elements are also more prone to corrosion and, owing to their lower temperature stability, cannot be exposed to such high temperatures as ceramic heat shield elements.

To minimize cracking it is hence as a rule endeavored to keep thermal loading of a heat shield's heat shield elements as low as possible.

### SUMMARY OF INVENTION

The object of the present invention is to make a heat shield element available in which the tendency to cracking has been reduced.

A further object of the present invention is to make an advantageous heat shield and a combustion chamber fitted with an advantageous heat shield available.

An object of the present invention is finally to make a method for producing advantageous heat shield elements available.

The first object of the invention is achieved by means of a heat shield element, the second object is achieved by means of a heat shield or, as the case may be, a combustion chamber, and the third object is achieved by means of a method.

An inventive heat shield element has a hot side required to face a hot medium, a cold side required to face away from the hot medium, and circumferential areas connecting the hot side to the cold side. The hot side, the cold side, and the circumferential areas delimit the heat shield element's material volume. The inventive heat shield element is characterized by the material volume's having at least two material regions that mutually differ in their thermal expansion coefficients.

With suitable thermal expansion coefficients it is possible to selectively influence the material regions' thermal expansion. The stresses arising within the heat shield element when a heat shield is in operation can be reduced particularly when material regions provided for relatively high operating temperatures have a relatively low thermal expansion coefficient and material regions provided for relatively low operating temperatures have a relatively high thermal expansion coefficient.

The inventive heat shield element is embodied as a ceramic heat shield element.

The reduction, due to the different thermal expansion coefficients, in stress formation when spatial temperature gradients occur within the ceramic heat shield element results in a reduced tendency to cracking. The risk of the formation of long cracks that would necessitate the heat shield element's replacement is thereby reduced in a ceramic heat shield. The reduced tendency to cracking will furthermore result in an increased service life for the heat shield elements and hence in reduced replacement rates for heat shield elements in hot gas linings.

In one embodiment of the inventive heat shield element at least one material region having a relatively low thermal expansion coefficient borders the hot side of the heat shield element, whereas at least one material region having a relatively high thermal expansion coefficient borders the cold side of the heat shield element. Greater temperature differences than on the heat shield element's cooled cold side occur on its hot side during the transition from the ambient temperature (for example when a gas turbine installation is at rest) to the maximum operating temperature (for example when a gas turbine installation is operating at maximum load). In the embodiment described these are equalized through the heat shield element's having a lower thermal expansion coefficient in the region of the hot side than in the region of the cold side. Suitably selecting the thermal expansion coefficients will allow the material expansion in the region of the cold side to be matched to the material expansion in the region of the hot side, as a result of which material stresses in the heat shield element can be reduced.

At least one material region having a relatively high thermal expansion coefficient can furthermore border the heat shield element's circumferential area and at least one material region having a relatively low thermal expansion coefficient as viewed from the circumferential areas can be located within the material volume. In that embodiment a material region having a relatively low thermal expansion coefficient can furthermore also border the hot side and a material region having a relatively high thermal expansion coefficient can border the cold side. Since owing to the stream of sealing air a heat shield's heat shield elements will cool particularly in the region of the circumferential areas, high stresses due to the particularly low operating temperatures compared to the rest of the heat shield element will occur in the region of the circumferential areas in heat shield elements having a homogeneous thermal expansion coefficient. Because the thermal expansion coefficient is raised in the region of the circumferential areas compared to the heat shield element's interior (as viewed from the circumferential areas), the stresses that occur can be reduced.

In a development of the inventive heat shield element mutually adjacent material regions having different thermal expansion coefficients are embodied such that a smooth transition will take place from one material region's thermal expansion coefficient to the other material region's thermal expansion coefficient in the zone of the transition from one material region to the other material region. The risk that the heat shield will be destroyed during production, in particular during the sintering process that takes place at a raised, roughly homogeneous temperature can be reduced owing to the thermal expansion coefficient's smooth transition.

An inventive heat shield, which can be embodied in particular as a heat shield for a gas turbine combustion chamber, includes a number of mutually bordering heat shield elements under an expansion gap load in their circumferential areas and a sealing fluid duct for ducting a stream of sealing fluid sealing the expansion gaps against the ingress of hot medium. Sealing air in particular can be used as the sealing fluid. The inventive heat shield is characterized by the heat shield elements' being embodied as inventive heat shield elements.

An inventive combustion chamber is lined with an inventive heat shield. The combustion chamber can be embodied in particular as a gas turbine combustion chamber.

The inventive method for producing a ceramic heat shield element entails press-molding or casting a basic composite material then sintering the press-molded or cast basic composite material. The inventive method is characterized in that sintering of the press-molded or cast basic composite material is preceded by setting the thermal expansion coefficients of different material regions. Setting the thermal expansion coefficients of different material regions will allow the resistance of a heat shield element produced using the inventive method to temperature gradients within the heat shield element to be increased.

The thermal expansion coefficients can be set by, for example, using basic composite materials having different compositions for the relevant material regions during press-molding or casting. The composition of the basic composite material can therein in particular be changed over smoothly from one composition to the other composition so that a smooth transition can be realized for the thermal expansion coefficient.

The thermal expansion coefficients can alternatively also be set by, when the basic composite material has been press-molded or cast and prior to sintering, post-treating at least one material region which, after sintering, is to have a thermal expansion coefficient that has been altered relative to the rest of the basic composite material, for example one that is relatively low. Post-treatment can consist in, for example, soaking the at least one material region requiring to be post-treated in a liquid. That procedural mode will allow material regions requiring to have a thermal expansion coefficient altered relative to the rest of the basic composite material to be particularly well established.

### BRIEF DESCRIPTION OF THE DRAWINGS

Further features, characteristics, and advantages of the present invention will emerge from the following description of exemplary embodiments with reference to the accompanying figures.

FIG. 1 is a perspective view of a heat shield element.

FIG. 2a shows a section through a first embodiment of the heat shield element shown in FIG. 1 along the line A-A.

FIG. 2b shows a section through a variant of the heat shield element shown in FIG. 2a along the line B-B in FIG. 1.

FIG. 3 shows a section through a second embodiment of the heat shield element shown in FIG. 1 along the line A-A.

FIG. 4 shows a section through a third embodiment of the heat shield element shown in FIG. 1 along the line A-A.

FIG. 5a shows a first step of a first production method for an inventive heat shield element.

FIG. 5b shows a second step of the production method shown in FIG. 5a.

FIG. 5c shows an alternative variant of the method shown in FIGS. 5a and 5b.

FIG. 6a shows a first step of a second production method for an inventive heat shield element.

FIG. 6b shows a second step of the method shown in FIG. 6a.

### DETAILED DESCRIPTION OF INVENTION

FIG. 1 is a perspective view of a heat shield element 1. The heat shield element 1 has a hot side 3 which, when the heat shield element 1 has been mounted in a heat shield, faces the hot medium. Opposite the hot side 3 is the cold side 5 of the heat shield element 1, which side, when said element has been mounted in a heat shield, faces the combustion chamber wall's supporting structure and hence faces away from the hot medium. The hot side 3 and cold side 5 are mutually connected via first circumferential areas 7 and second circumferential areas 9. The second circumferential areas 9 have grooves 11 into which fixing clamps (not shown) connected to the combustion chamber wall's supporting structure can engage to secure the heat shield element in position after being mounted in a ceramic hot gas lining. The first circumferential areas 7, by contrast, have no grooves.

The hot side 3, the cold side 5, the first circumferential areas 7, and the second circumferential areas 9 enclose the material volume of the heat shield element providing the thermal shielding effect.

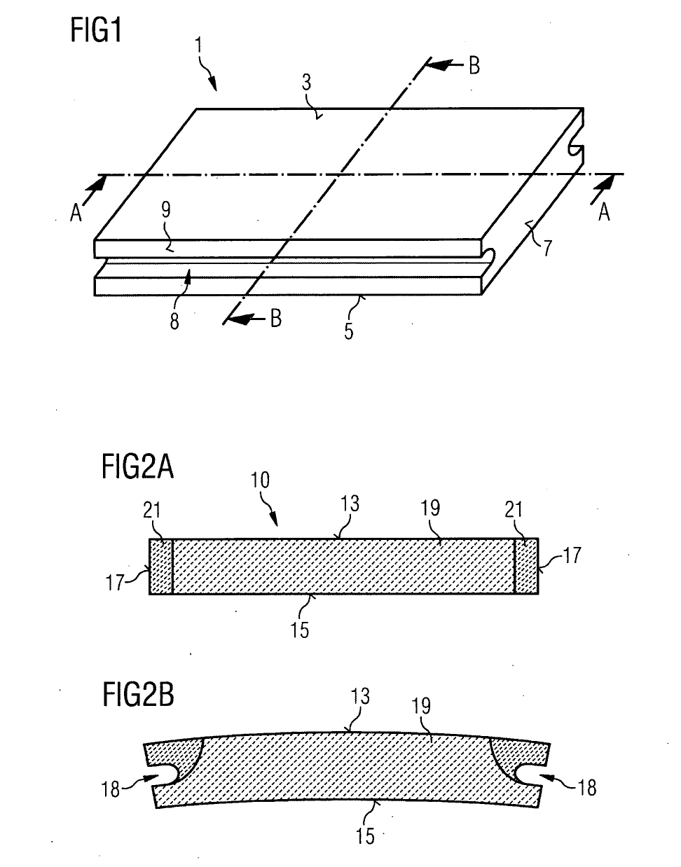

A section through a first embodiment of the inventive heat shield element is shown in FIG. 2a. Said section follows the line A-A shown in FIG. 1. What can be seen are the hot side 13, the cold side 15, and the groove-free circumferential areas 17 of the heat shield element 10 of the first embodiment. The heat shield element 10 has a first material region 19 and second material regions 21 that differ from the material region 19 in their thermal expansion coefficient. The thermal expansion coefficient of the material regions 21 is therein greater than the thermal expansion coefficient of the material region 19. The material region 19 has in this sense a relatively low thermal expansion coefficient, whereas the material regions 21 have a relatively high thermal expansion coefficient.

During the construction of a heat shield, for example for a gas turbine combustion chamber, the combustion chamber wall's supporting structure is lined over its entire surface with a number of heat shield elements 10. The heat shield elements 10 are therein attached mutually bordering in such a way that expansion gaps will remain between adjacent heat shield elements 10. Said expansion gaps serve to enable the heat shield elements 10 to expand, owing to the high operating temperatures while the combustion chamber is operating, without making mutual contact.

To prevent the hot medium, for example hot combustion gases, from penetrating through the expansion gaps to the combustion chamber wall's supporting structure, the expansion gaps are rinsed with sealing air serving simultaneously to cool the securing elements that secure the heat shield elements 10. Lower temperatures than in the central region 23 of the heat shield element 10 will, while the combustion chamber is operating, for that reason prevail in the first circumferential areas 17 around which sealing air is flowing and in the second circumferential areas (cannot be seen in FIG. 2a) around which sealing air is likewise flowing. A conventional heat shield element's centrally located material region 19 would, while the combustion chamber is operating, hence undergo greater thermally induced expansion than the material regions 21 located in the region of the circumferential areas. Tensile stresses will hence arise in the regions having a lower temperature that are linked flush to the area having a low temperature. Compressive stresses will correspondingly arise in the regions having the higher temperature. In other words, in a conventional heat shield element the relatively cool material regions 21 would as a result of their relatively low thermal expansion be subjected to tension by the hot central region 19 undergoing greater thermal expansion and could crack if the material strength is exceeded. The cracks would extend from the edges of the heat shield toward its interior. Cracking of said type can reduce a heat shield element's service life.

In the inventive heat shield element 10 the stresses described with reference to a conventional heat shield element will be reduced particularly in the cool circumferential regions because the material regions 21 have a higher thermal expansion coefficient than the central material region 19. The higher temperature of the central material region 19 will therefore be equalized by the greater thermal expansion coefficient of the material regions 21 in the region of the circumferential areas 17.

The thermal expansion coefficients of the material regions 19 or, as the case may be, 21 and the extent of said material regions in the material volume of the heat shield element 10 can be numerically optimized in such a way that the stresses in the heat shield element 10 will be minimized. For example the extent of the material regions 21 having relatively high thermal expansion coefficients can be established by first calculating the temperature field occurring in the targeted operating state under relevant boundary conditions in the heat shield element. Based on the result, the size of the regions 21 for the selected thermal expansion coefficient can then be set in such a way that the stresses in the heat shield element 10 will be minimized thereby. The thermal expansion coefficients and the extents of the material regions can, of course, also be optimized simultaneously. It is, though, also possible to specify the extent of, for example, the circumferential material regions 21 and establish suitable thermal expansion coefficients through optimizing.

In FIG. 2a there are in the region of the groove-free circumferential areas 17 of the heat shield element material regions 21 having a raised thermal expansion coefficient and reduced thermal conductivity compared to the central material region 19. The inventive heat shield element 10 can additionally or alternatively also have material regions 20 having a raised thermal expansion coefficient compared to the central material region 19 and reduced thermal conductivity in the region of the second circumferential areas, which is to say in the region of the circumferential areas provided with grooves 18 (FIG. 2b).

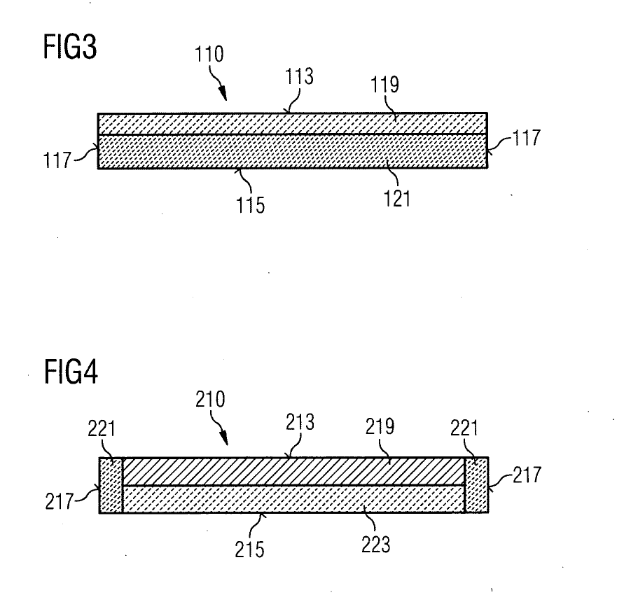

A section through a second embodiment of the inventive heat shield element is shown in FIG. 3. Said section follows the line A-A shown in FIG. 1. The hot side 113, the cold side 115, and the groove-free circumferential areas 117 of the heat shield element 110 can be seen accordingly.

The heat shield element 110 has on the hot side a material region 119 having a relatively low thermal expansion coefficient and relatively low thermal conductivity. On the cold side it has a material region 121 having a raised thermal expansion coefficient, a raised thermal conductivity, and a raised mechanical load rating compared to the material region 119 on the hot side. That embodiment takes account of the fact that the hot side 113 of a heat shield element is exposed to a higher temperature than the generally cooled cold side 115 while a combustion chamber is operating. A temperature gradient will thus form in the heat shield element 110 from the hot side 113 toward the cold side 115. The lower temperature of the material region 121 on the cold side will then be equalized while the combustion chamber is operating owing to said region's higher thermal expansion coefficient compared to the material region 119 on the hot side. Stresses due to the temperature gradient can therefore be reliably avoided.

A section through a third embodiment of the inventive heat shield element is shown in FIG. 4. Said section follows the line A-A shown in FIG. 1. The cold side 213, the hot side 215, and the groove-free circumferential areas 217 of the heat shield element 210 can be seen accordingly. The heat shield element 210 has a first material region 219 on the hot side having a first thermal expansion coefficient, second material regions 221 on the circumferential side having a second thermal expansion coefficient, and a material region 223 on the cold side having a third thermal expansion coefficient. The second and third thermal expansion coefficient can therein also be identical. Stresses occurring as a result of temperature gradients in the interior of the beat shield element 210 can be reliably minimized by suitably selecting the thermal expansion coefficients of the individual material regions.

Further combinations of material regions having mutually differing thermal and/or mechanical properties are possible, for example a combination of all material regions mentioned in the above-described exemplary embodiments.

In all three embodiments shown here of the inventive heat shield element there are relatively abrupt transitions between the different material regions and hence relatively abrupt transitions between different thermal expansion coefficients. The regions having different expansion coefficients ought, though, as far as possible to assume the form not of sharply delineated material properties but rather of smooth transitions between the material properties in order to avoid the risk that the heat shield will be destroyed during production, in particular during sintering that takes place at a raised, largely homogeneous temperature.

For the respective application it can be computationally determined and optimized how the thermal expansion coefficient needs to be varied so that on the one hand the heat shield element will not risk being destroyed during sintering and, on the other, an optimal effect for avoiding the formation of stresses during the operating state will simultaneously be achieved. For example an optimal casting mold or, as the case may be, pressing mold can be derived therefrom for producing a green body, meaning a pre-stage of the heat shield element made of a polymerceramic material in which there is a partial network of the polymer. Any changes in the heat shield element's shape during sintering can in that way be compensated.

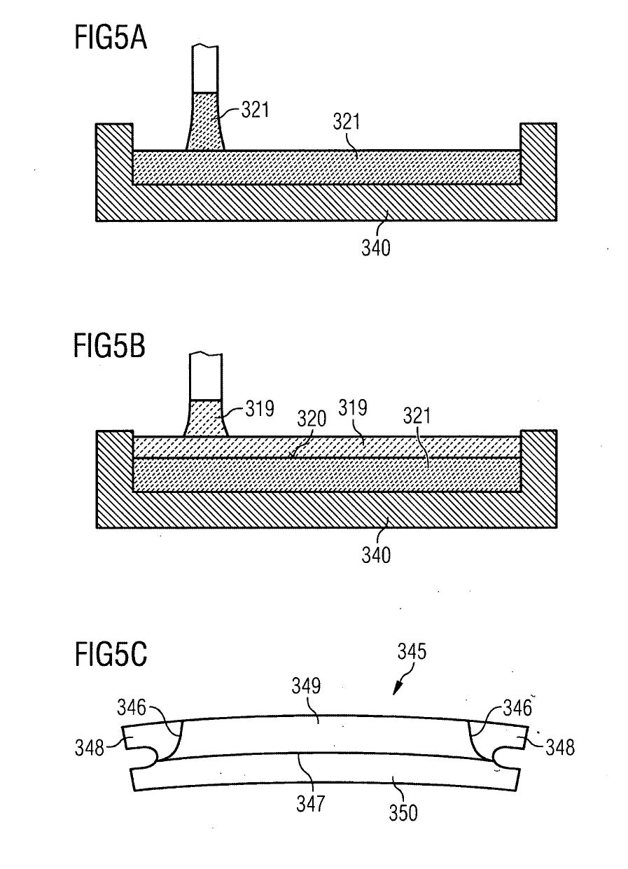

An exemplary embodiment of a method for producing an inventive heat shield element is described below with reference to FIGS. 5a and 5b. FIG. 5a shows a first step of the production method and FIG. 5b shows a second step thereof. The method comprises casting composite materials into a casting mold 340 in order thereby to mold a green body, then sintering the green body to fabricate the ceramic heat shield element.

Casting of the composite materials is shown in FIGS. 5a and 5b. A composite material 321 having a first composition is first cast into the casting mold 340 (FIG. 5a). A composite material 319 having a second composition is then cast over the first composite material 321. The consistency of the composite materials is therein such that the two composite materials will not completely mix. Mixing in the region of the boundary area 320 is, though, desired.

The compositions of the composite materials 319 or, as the case may be, 321 have been selected such that after sintering the composite material 319 will have a lower thermal expansion coefficient than the composite material 321.

Although mixing of the composite materials 319, 321 in the region of the boundary area 320 is desired in the case of the production method described, an inventive heat shield element can nonetheless also be produced without mixing of said type. A heat shield element as shown in FIG. 3 will be obtained when the cast heat shield element has been sintered.

In the variant described with reference to FIGS. 5b and 5b of casting an inventive heat shield element, said element is cast lying flat, which is to say either the part of the casting mold serving to mold the hot side or the part of the casting mold serving to mold the cold side will be the underside of the casting mold. In FIGS. 5a and 5b the part of the casting mold serving to mold the cold side is the underside, for example.

In an alternative variant of casting the heat shield element is cast in a standing casting mold, which is to say the part of the casting mold molding the cold side and the part of the casting mold molding the hot side will be side walls of the casting mold, whereas the underside of the casting mold will be a part of the mold molding one of the heat shield element's circumferential areas. Said variant of casting is shown in FIG. 5c that is a top view of a standing casting mold., Templates 346, 347 can in the standing casting mold 345 serve to mutually separate different regions 348, 349, 350 of the casting mold 345. Different composite materials are cast into the different regions 348, 349, 350. Three different composite materials, for example, can be used in the case of the mold shown in FIG. 5c, namely one for the regions 348, one for the region 349, and one for the region 350. It is, though, also possible likewise to use different composite materials for each of the mutually separated sections 348 so that in all four composite materials will be used. It is additionally possible, as described with reference to FIGS. 5a and 5b, also to successively cast different composite materials into a region.

The templates are removed after casting so that the cast composite materials will combine. The consistency of the composite materials has here, too, been selected such that the composite materials will mix in the region of the boundary areas when the templates have been removed.

It is, of course, also possible to use templates for subdividing the casting mold into different material regions when the casting mold is lying flat.

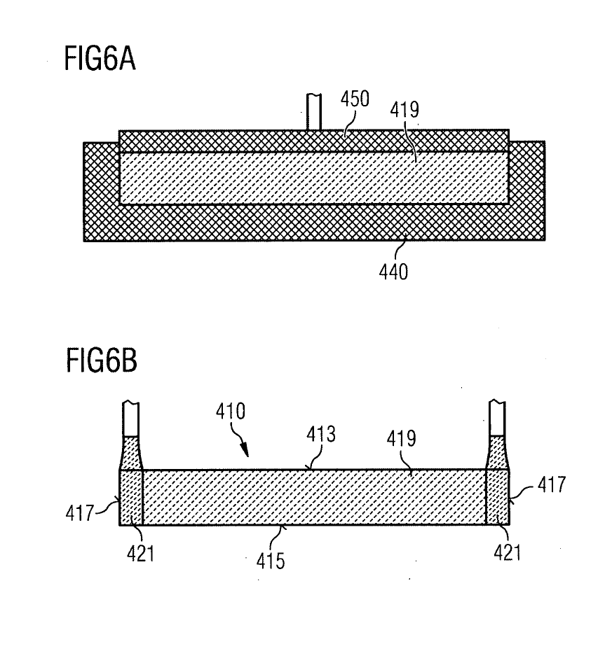

A second production method for inventive heat shield elements will now be described with reference to FIGS. 6a and 6b. With that method a composite material 419 is put into a pressing mold 440, 450 then pressed. The result is a green body 410 of the heat shield element. Said green body 410 is shown in FIG. 6b. The hot side 413, the cold side 415, and the groove-free circumferential areas 417 of the green body 410 can be seen. The green body 410 is soaked in the region of the groove-free circumferential areas 417 with a liquid influencing the sintering process. Said liquid has been selected such that the soaked regions 421 will have a higher thermal expansion coefficient after sintering than the non-soaked region 419.

The circumferential areas of the green body 410 (cannot be seen in FIG. 6b) that are provided with grooves can optionally also be soaked in order to raise the thermal expansion coefficient of the relevant regions. The result of the method described with reference to FIGS. 6a and 6b is a heat shield element as shown in FIG. 2.

Also when the heat shield element is press-molded it is possible to fill the mold either lying flat or standing and to use templates when it is filled with composite materials. The pressing mold can therein be set or, as the case may be, filled at any angle—as incidentally can also the casting mold when a heat shield element is cast.

Although the production of a heat shield element as shown in FIG. 3 has been described by way of example with reference to FIGS. 5a and 5b, it is nonetheless possible to produce heat shield elements as shown in FIGS. 2 or 4 using the same method. The same applies to the method described with reference to FIGS. 6a and 6b. Similarly here, it is possible, using said method, to produce not only a heat shield element as described with reference to FIG. 2 but also heat shield elements as shown in FIGS. 3 or 4.

1.-12. (canceled)

13. A ceramic heat shield element, comprising:
a hot side operatively facing a hot medium;
a cold side operatively facing away from the hot medium;
a plurality of circumferential areas that span between the hot side to the cold side; and
a material volume delimited by the hot side, the cold side, and the plurality of circumferential areas, the material volume comprised of a plurality of material regions where each region has a different thermal expansion coefficient.

14. The heat shield element as claimed in claim 13, wherein an individual material region of the plurality of material regions is provided for an intended operating temperature.

15. The heat shield element as claimed in claim 14, wherein an individual material region of the plurality of material regions provided for relatively high operating temperatures have a relatively low thermal expansion coefficient, and material regions provided for relatively low operating temperatures have a relatively high thermal expansion coefficient.

16. The heat shield element as claimed in claim 15, wherein at least one material region having a relatively low thermal expansion coefficient borders the hot side and at least one material region having a relatively high thermal expansion coefficient borders the cold side.

17. The heat shield element as claimed in claim 16, wherein at least one material region having a relatively high thermal expansion coefficient borders the circumferential areas and at least one material region having a relatively low thermal expansion coefficient as viewed from the circumferential areas is located within the material volume.

18. The heat shield element as claimed in claim 17, wherein mutually adjacent material regions having different thermal expansion coefficients are embodied such that a smooth transition takes place from one material region's thermal expansion coefficient to the other material region's thermal expansion coefficient in a zone of the transition from one material region to the other material region.

19. A gas turbine combustion chamber hot gas lining, comprising:
a combustion chamber surface; and
a plurality of heat shield elements having an expansion gap load, the elements arranged on the chamber surface and adjacent to one another to form a sealing fluid duct for ducting a stream of sealing fluid that seals the expansion gaps against the ingress of a hot medium, wherein the plurality of heat shield elements have:
a hot side operatively facing a hot medium,
a cold side operatively facing away from the hot medium,
a plurality of circumferential areas that span between the hot side to the cold side, and
a material volume delimited by the hot side, the cold side, and the plurality of circumferential areas, the material volume comprised of a plurality of material regions where each region has a different thermal expansion.

20. A method for producing a ceramic heat shield element, comprising:
setting thermal expansion coefficients of different material regions of a basic composite material;
forming the basic composite material; and
sintering the formed basic composite material.

21. The method as claimed in claim 20, wherein the ceramic heat shield element is formed by casting or press-molding.

22. The method as claimed in claim 21, wherein the thermal expansion coefficients are set by basic composite materials having different compositions for the relevant material regions during press-molding or casting.

23. The method as claimed in claim 22, wherein the composition of the basic composite material changes smoothly from one composition to a different composition while adjacent material regions are press-molded or cast.

24. The method as claimed in claim 23, wherein the thermal expansion coefficients are set by treating at least one material region before sintering and after forming to have a thermal expansion coefficient that has been altered relative to the rest of the basic composite material.

25. The method as claimed in claim 24, wherein the at least one material region is treated by soaking the at least one material region in a liquid.
